(19) United States
(12) Patent Application Publication
(10) Pub. No.: US 2012/0323633 A1
(43) Pub. Date: Dec. 20, 2012

(54) SUPPLY CHAIN MANAGEMENT SOLUTION

(75) Inventors: Pawan R. Chowdhary, Montrose, NY (US); Youssef Drissi, Ossining, NY (US); Mary E. Helander, North White Plains, NY (US); Kaan K. Katircioglu, Yorktown Heights, NY (US); Lin Li, Colleyville, TX (US); Min Min Qiu, Beijing (CN); Karthik Sourirajan, White Plains, NY (US); Karthik Subbian, BKarnataka (IN); Takashi Yonezawa, Kanagawa-ken (JP)

(73) Assignee: INTERNATIONAL BUSINESS MACHINES CORPORATION, Armonk, NY (US)

(21) Appl. No.: 13/162,240

(22) Filed: Jun. 16, 2011

(51) Int. Cl. G06Q 10/00

(52) U.S. Cl. 705/7.31; 705/7.11

(57) ABSTRACT

A method, system and computer program product are disclosed for providing an integrated solution to a set of supply chain optimization problems. In one embodiment, the method comprises defining a distribution network, vehicle routing, inventory positioning, and environmental sustainability for a supply chain; and combining an optimization of the distribution network, the vehicle routing, the inventory positioning, and the environmental sustainability into a single problem. In an embodiment, the optimization of the distribution network, the vehicle routing, the inventory positioning, and the environmental sustainability are combined into a single problem by using analytical engines. In one embodiment, these analytical engines include an inventory positioning engine to identify an inventory policy, a network analysis engine to identify a network structure, a vehicle routing engine to identify routes for delivering products, and a sustainability engine to quantify energy use and carbon emissions of defined actions.

### BACKGROUND OF THE INVENTION

The present invention generally relates to supply chain management, and more specifically, to an integrated solution to a set of supply chain problems.

In order to maximize the overall efficiency and profitability of a supply chain while eliminating or reducing negative environmental impacts, different components and areas of the supply chain need to be optimized. These areas include inventory positioning, distribution network analysis, vehicle routing, and sustainability. Optimizing each area or component individually might not result in an optimal solution for the overall supply chain since these areas are interconnected. In order to reach the optimal policy decisions and problem solutions, there is a need for an integrated solution that addresses the different supply chain areas and optimization problems together, instead of focusing only on one optimization problem at a time.

### BRIEF SUMMARY

Embodiments of the invention provide a method, system and computer program product for providing an integrated solution to a set of supply chain optimization problems. In one embodiment, the method comprises defining a distribution network, vehicle routing, inventory positioning, and environmental sustainability for a supply chain; and combining an optimization of the distribution network, the vehicle routing, the inventory positioning, and the environmental sustainability into a single problem.

In an embodiment, strategic and tactical supply chain operations and goals are defined, and a decision support system combines these strategic and tactical supply chain operations and goals.

In one embodiment, the supply chain has a plurality of operational levels, and high level views and operational level views of the supply chain are provided. The high level views may include a profit and loss view.

In an embodiment, the optimization of the distribution network, the vehicle routing, the inventory positioning, and the environmental sustainability are combined into a single problem by using a plurality of analytical engines. In one embodiment, these analytical engines include an inventory positioning engine to identify an inventory policy based on defined factors including inventory costs and customer service targets, and a network analysis engine to identify a network structure and a supply flow in the network structure for each of a plurality of product groups.

In one embodiment, the analytical engines further include a vehicle routing and customer clustering engine to identify routes for delivering the products to a multitude of customers, and a sustainability engine to quantify an impact of defined actions in the supply chain on energy use and carbon emissions. In one embodiment, the analytical engines further include a demand estimation engine to estimate a demand over a specified time period from each of a multitude of customer locations for each of a plurality of items.

In one embodiment, the vehicle routing and customer clustering engine clusters the multitude of customers into a multitude of customer clusters. In an embodiment, the sustainability engine quantifies the impact of specified operational actions in the supply chain on the energy use and carbon emission in warehouse and transportation operations and identifies ways to reduce said energy use and carbon emissions.

In an embodiment, the vehicle routing and customer clustering engine provides input to the network analysis engine and to the sustainability engine, the network analysis engine provides input to the sustainability engine and to the inventory positioning engine, and the inventory positioning engine provides input to the sustainability engine.

In one embodiment, the vehicle routing and customer clustering engine assigns customer to routes and assigns routs to cross-docks, and computes demand at the cross-docks. In an embodiment, the network analysis engine assigns cross-docks to local distribution centers and assigns local distribution centers to vendors and to regional distribution centers, and computes demand at the local distribution centers. In one embodiment, the Inventory Positioning engine determines inventory policy at the regional distribution centers and the local distribution centers, and evaluates alternative supply chains.

Embodiments of the invention provide the following features:

i) Combining Network Analysis, Vehicle Routing, Inventory Positioning, and Sustainability into a single problem;
ii) Providing a decision support system that combines strategic and tactical operations and goals;
iii) Board Room Connection: providing solution views and reports at the Board Room level (profit and loss), as well as at the operational level;
iv) Unified Scenario Generation: allowing the user to generate scenarios that might affect different areas of the supply chain operations;
v) Smart Scenario Management Layer for deciding which engines to invoke based on the user's scenario data;
vi) Smart reports that allow the user to drill-down from high-level views to low-level operational views and navigate through different dimensions of the data; and
vii) Map-enabled reports and scenario generation (e.g., if the user drills down into a lower level of data, then the map component should reflect the corresponding data dynamically).

### BRIEF DESCRIPTION OF THE SEVERAL VIEW OF THE DRAWINGS

FIG. 1 provides an overview of an embodiment of the invention.

FIG. 2 identifies analytical engines that are used in an embodiment of the invention.

FIG. 3 illustrates a relationship between the analytical engines of FIG. 2.

FIG. 4 shows the operation of the Vehicle Routing and Customer Clustering Engine and shows several data tables used with that Engine.

FIG. 5 depicts inputs to and outputs from the Vehicle Routing and Customer Clustering Engine.

FIG. 6 illustrates the operation of a Demand Estimation Engine.

FIG. 7 shows the operation of the Network Analysis Engine of FIG. 3 and shows data tables used therewith.

FIG. 8 illustrates the operation of the Inventory Engine of FIG. 3 and shows several data tables used with that Engine.

FIG. 9 depicts the operation of the Profit and Loss Engine of FIG. 3 and shows several data tables used with that Engine.

FIG. 10 shows the operation of the Sustainability Engine of FIG. 3 and shows data tables used therewith.

FIG. 11 shows a computing environment that may be used to implement an embodiment of the invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

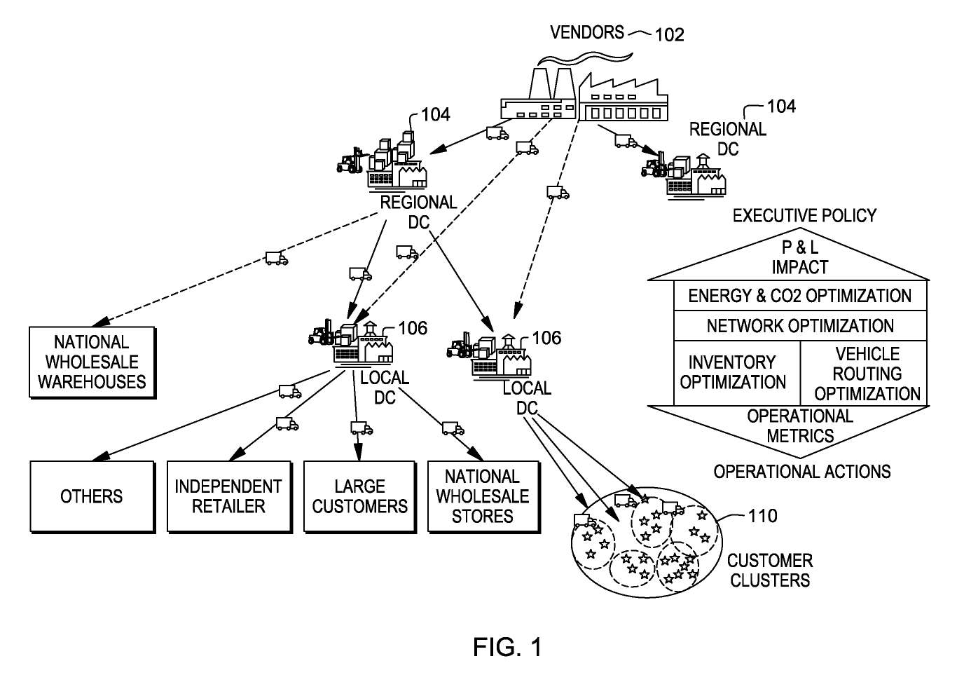

The present invention generally relates to supply chain management, and FIG. 1 illustrates an implementation of an embodiment of the invention. In this implementation, products are made by vendors 102 and transported to distribution centers, which may be regional distribution centers 104 or local distribution centers 106. From the distribution centers, the products may be delivered to a variety of destinations such as national warehouses, independent retailers, customers, or national whole sale stores. In this implementation, and as discussed in more detail below, customers may be grouped into customer clusters, one of which is shown at 110.

Embodiments of the invention may be used to link operational decisions to a Board Room view—that is, provide profit and loss impact estimation. Embodiments of the invention may provide model sustainability in a broader sense (operational, financial, environmental), integrate key supply chain planning areas in one model (inventory, network, routing), and create an inventory of all energy using equipment and quantify energy use in relation to supply chain decisions. Embodiment of the invention may also provide extensive “what-if” analysis to help establish cost effective sustainability policies, and provide a user friendly web-based integrated dashboard.

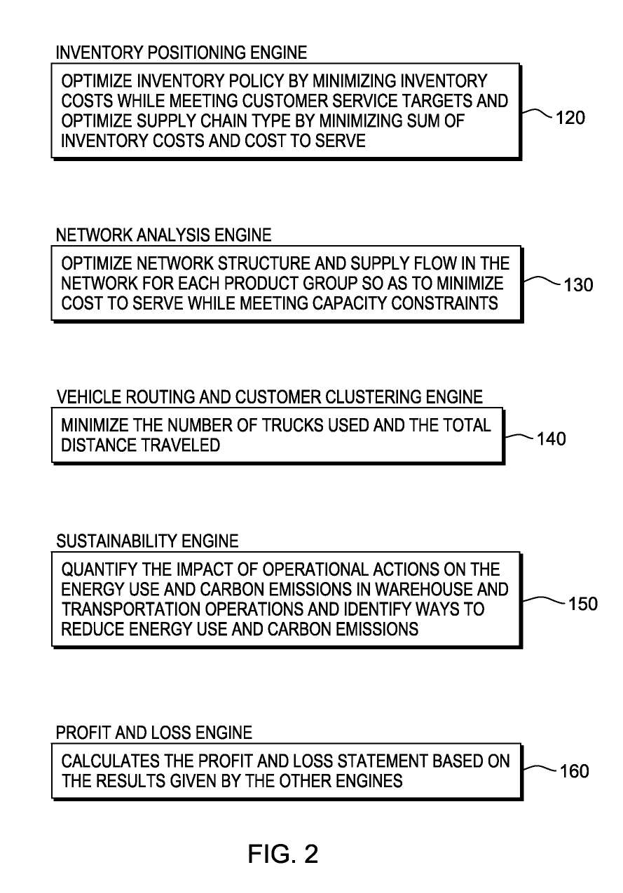

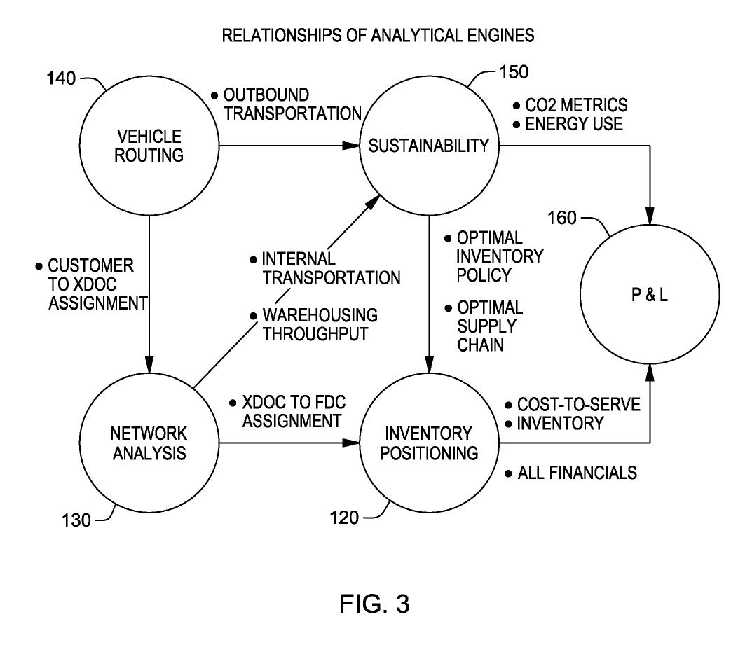

FIG. 2 shows five analytics engines that are used in an embodiment of the invention, and FIG. 3 illustrates relationships of these engines.

The five engines shown in FIG. 2 include an inventory positioning engine 120, a network analysis engine 130, a vehicle routing and customer clustering engine 140, a sustainability engine 150, and a profit and loss (P & E) engine 160. Generally, the inventory positioning engine 120 optimizes inventory policy by minimizing inventory costs while meeting customer service targets and optimizes supply chain type by minimizing the sum of inventory costs and the cost to serve. The network analysis engine 130 optimizes the network structure and supply flow in the network for each product group so as to minimize the cost to serve while meeting capacity constraints.

The Vehicle Routing and Customer Clustering Engine 140 minimizes the number of trucks used and the total distance traveled. The sustainability engine 150 quantifies the impact of operational actions on the energy use and carbon emissions in warehouses and transportation operations, and identifies ways to reduce energy use and carbon emissions. The Profit and Loss engine 160 calculates the profit and loss statement based on the results given by the other engines.

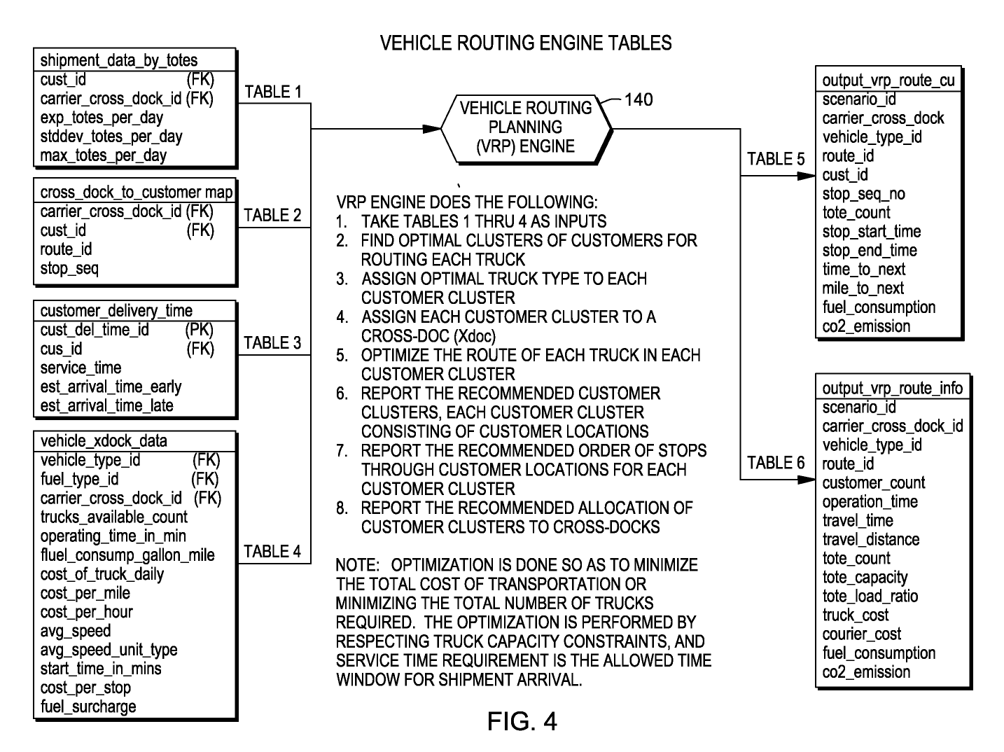

FIGS. 4-10 illustrate the operations of these analytical engines in more detail. Generally, in their operation, each of these engines receives data from one or more tables, processes that data, and then outputs data to one or more other tables.

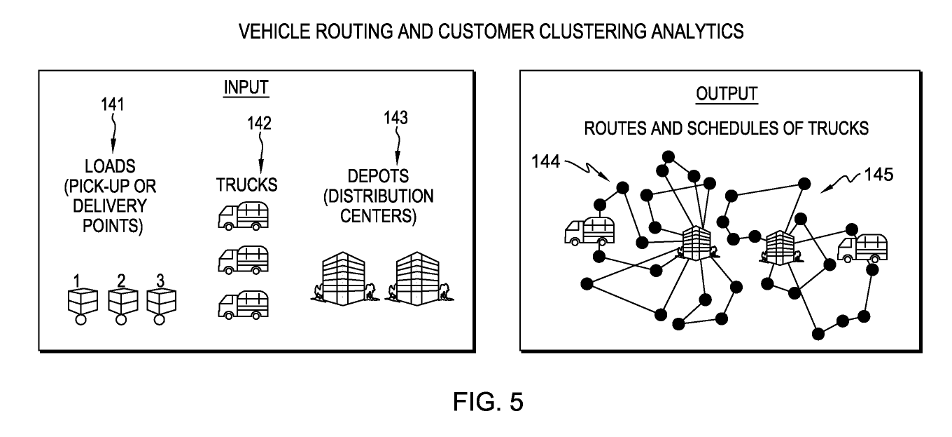

FIGS. 4 and 5 depict the operation of the Vehicle Routing and Customer Clustering Engine 140. This engine receives data from Tables 1 and 2. Table 1 includes customer related information such as address, delivery date, shipment contents, a route ID, a stop ID, and service requirements. Table 2 includes vehicle information such as vehicle type and location, vehicle count, fuel consumption, fuel type, and operating costs. As represented in FIG. 5, the input includes pick-up and delivery information, represented at 141, vehicle information, represented at 142, and information, represented at 143, about distribution centers.

The Vehicle Routing and Customer Clustering Engine takes Tables 1 and 2 as inputs, and finds optimal clusters of customers for routing each truck using a clustering algorithm. Each customer cluster is comprised of customer locations; and the Engine 140 assigns an optimal truck type to each customer cluster, assigns each customer cluster to a cross-dock (Xdoc), and optimizes the route of each truck in each customer cluster. Two customer clusters and the associated truck routes are represented truck routes are represented at 144 and 145 in FIG. 5. The Vehicle Routing and customer Clustering Engine reports the recommended customer clusters, reports the recommended order of stops through customer locations for each customer cluster, and reports the recommended allocations.

The optimization of the truck type to each customer cluster is done so as to minimize the total cost of transportation or to minimize the total number of trucks required. The optimization is performed by respecting truck capacity constraints and service time requirements for each customer location. Service time requirement is the allowed time window for shipment arrival. Any suitable optimization tool that fits the problem can be used. Suitable routing and clustering algorithms are known in the art and, for example, suitable algorithms are available at the web site for LionHeart Publishing Co.

The output of the Vehicle Routing and Customer Clustering Engine 140 is stored in Tables 3 and 4. Table 3 includes: Customer location id: input from Table 1; Original location id (location that makes the shipment): This is the Vehicle location id (site out of which it operates) in Table 2; Route id (which route the customer is on): calculated by a routing optimization algorithm; Shipment contents (list of product IDs and their quantities): input from Table 1; Shipment weight/volume/count: input from Table 1; Stop start time (predicted time of arrival): calculated by a routing optimization algorithm; Stop end time (predicted time of departure): calculated by a routing optimization algorithm; Time to next location: calculated by a routing optimization algorithm; Miles to next location: calculated by a routing optimization algorithm; Fuel consumption (between this customer location id and the next)=Fuel consumption (per mile)×Mile to next location; and CO2 emission (between this customer location id and the next)×CO2 emission (grams per gallon of fuel).

Table 4 includes: Route id: calculated by a routing optimization algorithm; Origin location id (location that makes the shipment): This is Vehicle location id (site out of which it operates) in Table 2; list of customer locations visited: calculated by a routing optimization algorithm Time period (day/week/month/quarter/year/custom): calculated by a routing optimization algorithm; Total travel miles: calculated by a routing optimization algorithm; Shipment weight/volume/count: calculated by a routing optimization algorithm; Vehicle id: assigned by a routing optimization algorithm to route id; and Transportation cost (truck cost, courier cost, fuel cost, labor cost, CO2 emission): This is the total cost of transport to given customer location id calculated by a routing optimization algorithm using unit costs and other inputs given in tables 1 and 2.

Inputs in Table 1 come from shipment transaction management system. Inputs in Table 2 come from an asset management system or any other source where information is kept.

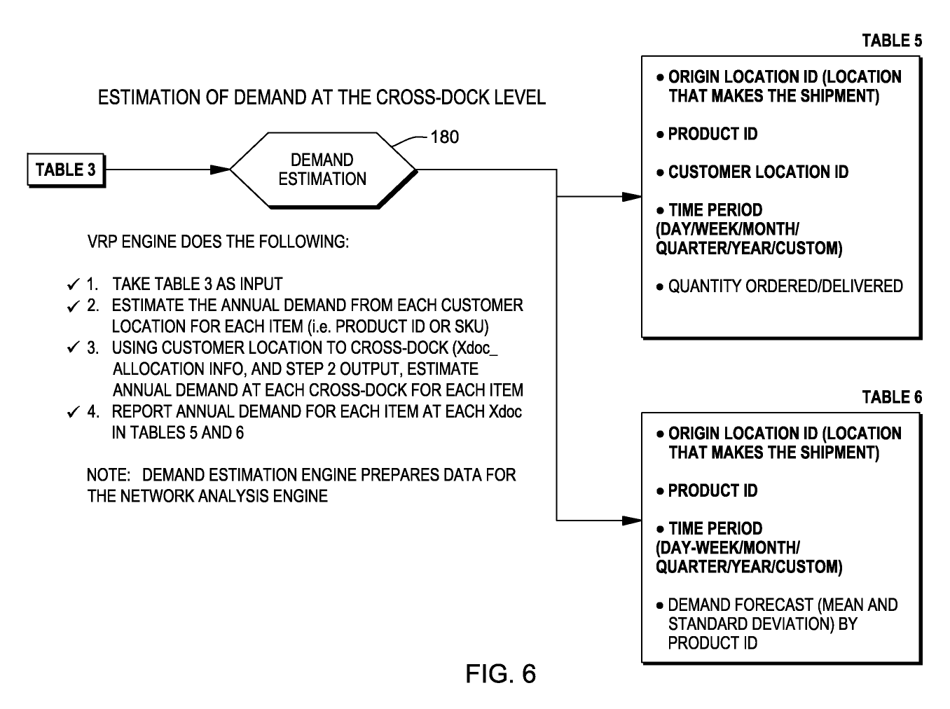

With reference to FIG. 6, Table 3 is used to determine a demand estimate. The Demand Estimation Engine 180 takes Table 3 as input and estimates the annual demand from each customer location for each item (i.e., product ID or SKU). Using customer location to cross-dock (Xdoc) allocation information, and the above-annual demand estimate, Engine 180 estimates the annual demand at each cross-dock for each item. The annual demand for each item at each cross-dock is reported in Table 6.

The Demand Estimation Engine 180 prepares data for the Network Analysis Engine 130. The Demand Estimation Engine can use any suitable statistical forecasting method/algorithm/software to calculate demand forecast from sales (in units) in Table 5.

Table 6 includes: Origin location id (location that makes the shipment): comes from Table 3; Product id: comes from Table 5; Customer location id: comes from Table 3; Time period (day/week/month/quarter/year/custom): Table 5; Quantity ordered/delivered: Sales (in units) from Table 5; and Demand forecast (mean and standard deviation) by product id: Any statistical forecasting method/algorithm/software can be used to calculate demand forecast based on sales (in units) data in Table 5.

Inputs in Table 3 come from the Vehicle Routing and Customer Clustering Engine 140, and inputs in Table 5 come from a sales transaction system.

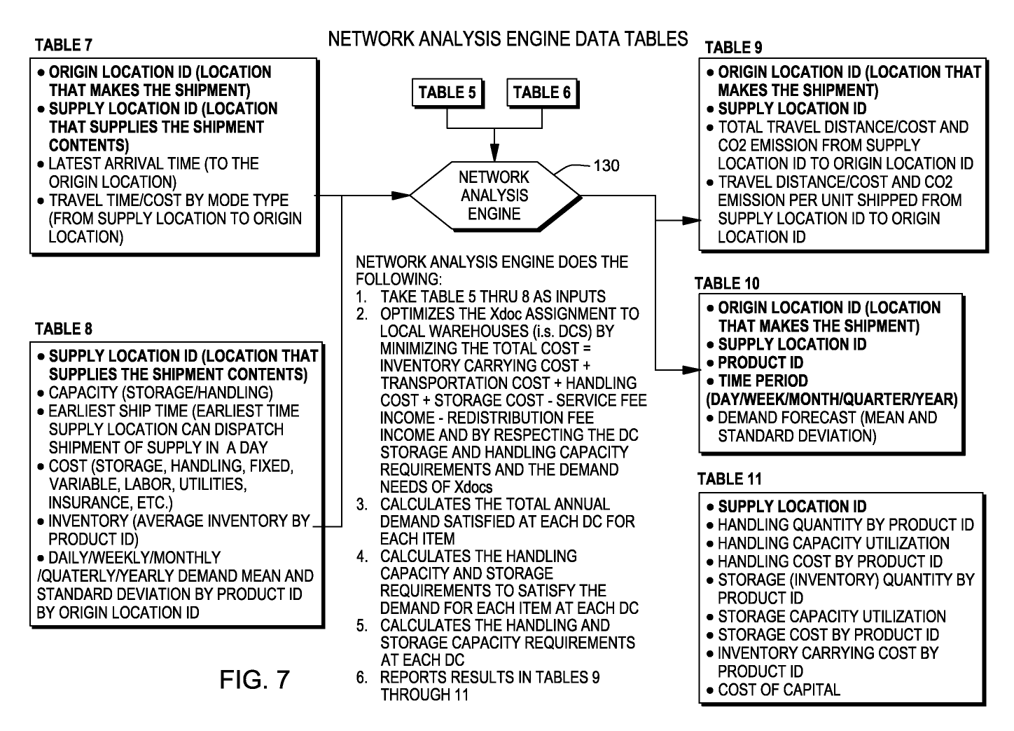

FIG. 7 shows the operation of the Network Analysis Engine 130. This Engine receives input from Tables 5, 6, 7 and 8. Table 7 includes data relating to the supply product, such as origin location ID, a supply location ID, a latest arrival time, and travel time/cost by mode type. Table 8 includes information relating to the supply location, such as a supply location ID, capacity, an earliest ship time, cost and inventory.

The Network Analysis Engine optimizes the Xdoc assignment to local warehouses (i.s. DCs) by minimizing the total cost=inventory carrying cost+transportation cost+handling cost+storage cost−service fee income−redistribution fee income, and by respecting the DC storage and handling capacity requirements and the demand needs of Xdocs. This optimization is done by using any suitable network optimization algorithm. Suitable network optimization algorithms are known in the art and are available, for example, at the wet sites for LLamasoft, Chainlytics, Profitpoint, The International business Machines Corp., and the JDA Software group. The Network Analysis Engine also calculates the total annual demand satisfied at each DC for each item, calculates the handling capacity and storage requirements to satisfy the demand for each item at each DC, and calculates the handling and storage capacity requirements at each DC. Results are reported in Tables 9 through 11.

Table 10 includes: Original location id (location that makes the shipment): comes from Table 8; Supply location id: comes from Table 7 and association of origin location id, and supply location id is done by a network optimization algorithm; Product id: comes from Table 6; Time period (day/week/month/quarter/year): comes from Table 6; and Demand forecast (mean and standard deviation): comes from Table 6.

Table 11 includes: Supply location id: comes from Table 7; Handling quantity by product id=Demand forecast (mean) by product id from Table 6; Handling capacity utilization=Total Handling quantity by product id for all product id's/Capacity (handling) from Table 8; Handling cost by product id=Demand forecast (mean) by product id from Table 6×Unit cost (handling) from Table 8; and Storage (inventory) quantity by product id=Inventory (average inventory by product id)*Demand forecast (mean) by product id from Table 6/Quantity ordered/delivery by product id from Table 8.

Table 11 also includes: Storage capacity utilization=Sum of Storage (inventory) quantity by product id for all product id's/Capacity (storage) from Table 8; Storage cost by product id=Unit cost (storage) by product id from Table 8*Storage (inventory) quantity by product id; Inventory carrying cost by product id=Unit inventory carrying cost by product id*Storage (inventory) quantity by product id; Supply transportation cost: Sum of all travel costs for all origin location id from Table 7; and Cost of capital: User input.

Inputs in Table 7 come from the user and a typical source is a logistics management system. Inputs in Table 8 come from the user and a typical source is a warehouse management system. Inputs in Table 6 come from the Demand Estimation Engine. Cost of capital cost is a user input and typically comes from finance.

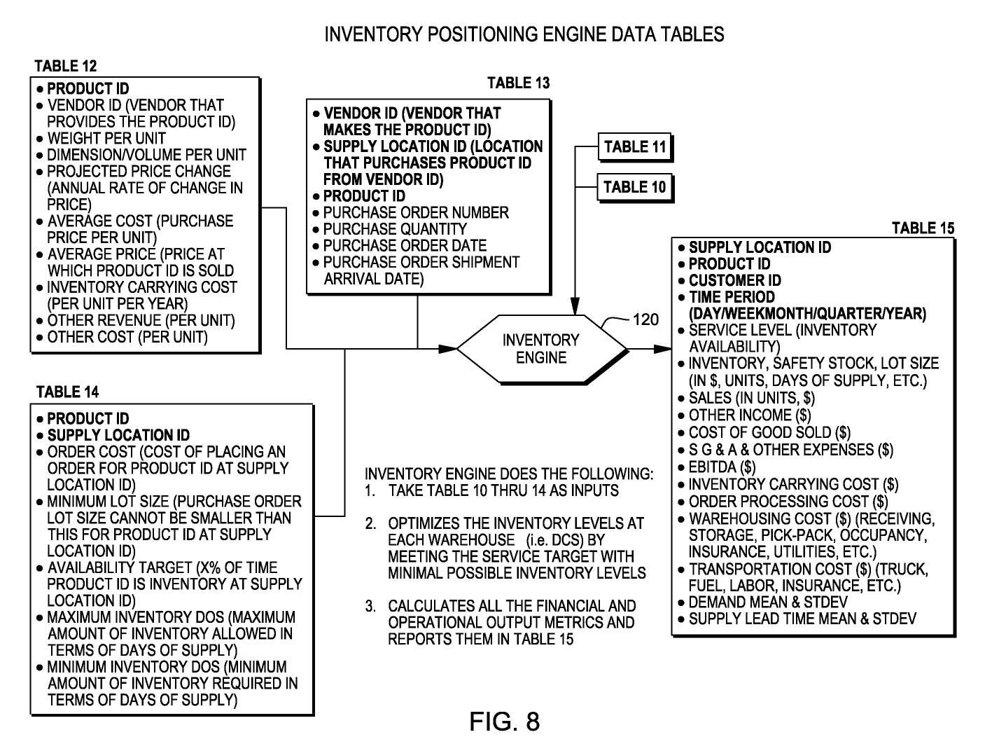

With reference to FIG. 8, in operation, Inventory Engine 120 takes Tables 10-14 as inputs and optimizes the inventory levels at each warehouse (i.e., DCs) by meeting the service target with minimal possible inventory levels. This optimization can be done using any suitable multi-echelon inventory optimization algorithm. Suitable inventory optimization algorithms are known in the art and are available, for instance, at the web sites for SmartOps, DemandWorks, JustEnough, TCLogic, and the JDA Software Group. The Inventory Engine calculates all the financial and operational output metrics and reports them in Table 15.

Table 15 includes: Supply location id: comes from Table 13; Product id: comes from Table 13; Customer id: comes from Table 10; Time period (day/week/month/quarter/year): comes from Table 10; Service level: comes from Table 14; and Inventory, safety stock, lot size (in $, units, days of supply, etc.): calculated using a multiechelon inventory optimization algorithm. It is allocated to customer location id by using revenue share of the customer location id.

Table 15 also includes: Inventory carrying cost=Inventory (units)*Inventory carrying cost (per unit per year) in Table 12*Average cost (purchase price per unit) in Table 12; Number of supply orders: calculated using a multiechelon inventory optimization algorithm; Order processing cost=Order cost (cost of placing an order for product id at supply location id) from Table 12*Number of supply orders; Warehousing cost: Calculated by adding Handling cost by product id and Storage; cost by product id from Table 11 and allocating the sum by the weight, volume or revenue share of product id and customer id combination; and Supply transportation cost: comes from Table 11 and allocated by using weight, volume, or revenue share of product id and customer id combination.

Table 15 also includes: Sales transportation cost: This is the Transportation cost from Table 4 and it is allocated to product id by using the weight, volume or revenue share of the product id; Demand during a period (mean & stdev): comes from Table 10; Supply lead time (mean & stdev)=Mean and Stdev of all (Purchase order shipment arrival date−Purchase order date) given in Table 13. Calculated by product id, by location id; and Demand during supply lead time (mean & stdev): Mean and Stdev of (Supply lead time*Demand during a day). Calculated by product id, by location id.

Inputs in Table 12 are user inputs and typically come from a Product Specification Data System, and inputs in Table 14 are user inputs and typically come from Inventory Management System. Inputs in Table 13 are user inputs and typically come from Procurement Transaction System, and Tables 10 and 11 come from the Network Analysis Engine.

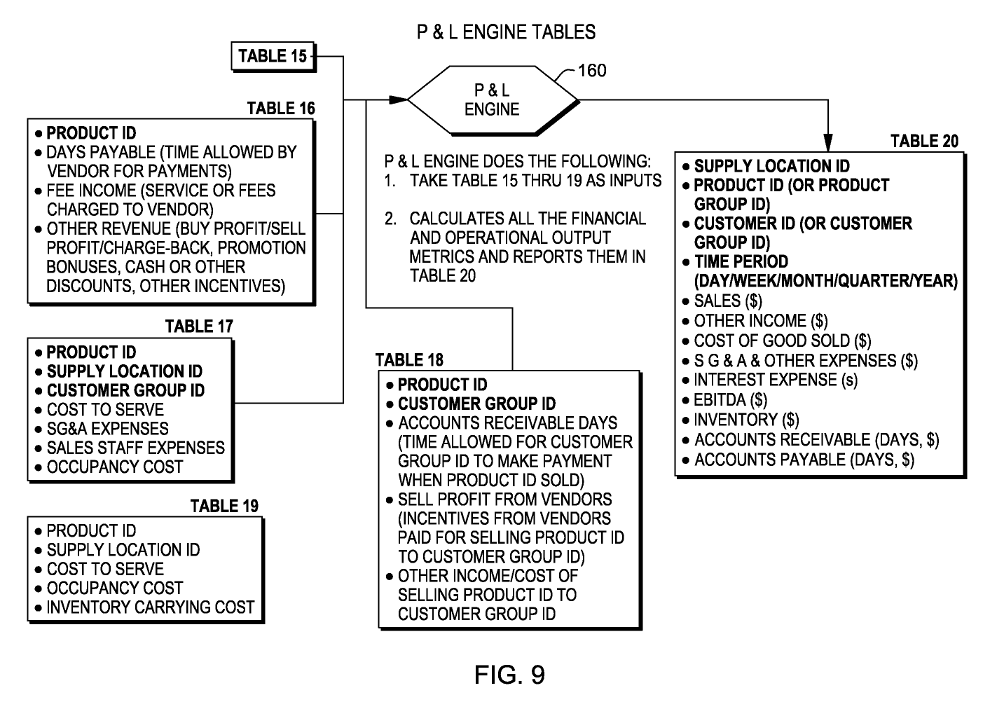

The operation of the Profit and Loss Engine 160 is illustrated in FIG. 9. This Engine takes Tables 15-19 as inputs and calculates all the financial and operations output metrics and reports them in Table 20.

Tables 16-18 include financial data such as fee income, other revenue, sales staff expenses, occupancy costs, inventory carrying costs, account receivable data, and other sales expenses.

Table 20 includes: Supply location id: comes from Table 15; Product id (or product group id): comes from Table 15; Customer id (or customer group id): comes from Table 15; Time period (day/week/month/quarter/year/custom): comes from Table 15; Sales=Average sales price per unit from Table 16*Sales quantity from Table 15; and Other income: Fee income (service or fees charged to vendor) per unit sold*Sales*Average sales price per unit from Table 16*Sales quantity from Table 15+Other revenue (buy profit/sell profit/charge-back, promotion bonuses, cash or other discounts, other incentives) per unit sold*Average sales price per unit from Table 16 Sales quantity from Table 15+Sell profit from vendors (incentives from vendors paid for selling product id to customer group id)*Average sales price per unit from Table 16*Sales quantity from Table 15+Other income/cost of selling product id to customer group id*Average sales price per unit from Table 16*Sales quantity from Table 15.

Table 20 also includes: Cost of goods sold=Average purchase cost per unit from Table 16*Sales quantity from Table 15; Cost of Operations=Sum of Sales staff expenses, Cost to serve, Occupancy cost from Table 17, Warehousing cost, Supply transportation cost, Sales transportation cost from Table 15; S G & A: comes from Table 17; and Interest expense=Inventory ($) from Table 15*Capital of capital; EBITDA: This is the earnings before income tax, depreciation and amortization and is given by the formula: Sales+Other income−Cost of goods sold−Cost of Operations−S G & A−Interest expense.

Table 20 also includes: Tax=Tax rate*(EBITDA−depreciation=amortization); Net Income=EBITDA−Tax; Inventory=Inventory ($) form Table 15; Accounts receivable (days)=Accounts receivable days (time allowed for customer group id to make payment when product id sold) from Table 18; Accounts payable (days)=Days payable (time allowed by vendor for payments) from Table 16; Accounts receivable (&)=Accounts receivable (days)*Average sales per day; and Accounts payable ($)=Accounts payable (days)*Cost of goods sold per day.

Data in Tables 16, 17, 18 are user inputs and typically come from finance. Inputs in Table 15 come from the Inventory Engine. Cost of capital is the annual rate of capital cost and typically comes from finance.

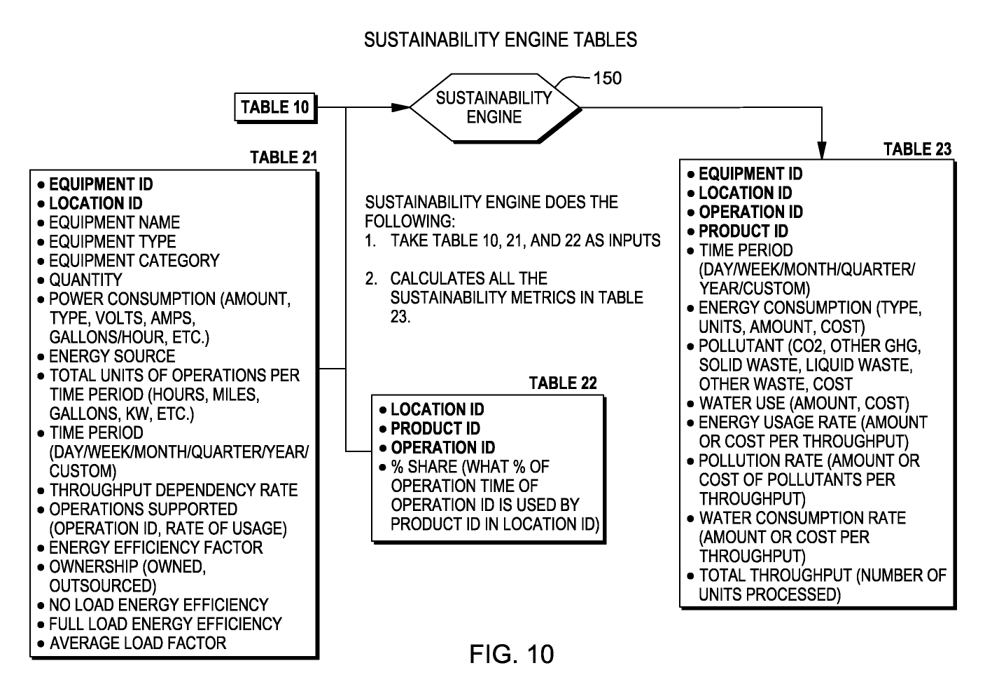

FIG. 10 illustrates the operation of the Sustainability Engine 150. This Engine takes Tables 10, 21 and 22 as inputs, and calculates sustainability metrics reported in Table 23.

The following notation is used in connection with the Sustainability Engine calculations:

i: location index
k: SKU index
j: equipment index
n: operation index
t: energy type index
T(ik): Throughput in location i for SKU k
EE(ijt): Type t energy use in location i of equipment j (KJ)
REE(ij): Revised energy use in location i of equipment j (KJ)
ECO(ij): Carbon emission of equipment j in location i (tons)
R(ijt): Rate of type t energy consumption of equipment j in location i (KJ per hour)
H(ij): Hours of operation of equipment j in location i (KJ)
LE(it): total energy use in location i for energy type t (KJ)
RLE(it): revised total energy use in location i (can come from total energy bills for energy type t)
LCO(i): total carbon emission in location i (KJ)
OE(in): total energy consumption in operation n in location i
OCO(in): total carbon emission in operation n in location i
W(ink): Weighting to use to allocate energy consumption of operation n in location i to SKU k (Wink could be the price of SKU k or its cost or its volume, or time it takes in operation n, etc.)
CO(ijt): carbon multiplier for equipment j in location i for energy type t (tons per KJ)
SCO(ijk): carbon emission contribution of equipment j to SKU k in location i (tons)
O(ijn): share of operation n in the use of equipment j in location i (=hours of operation of equipment j in operation n in location i/total hours of operation of equipment j in location i)
SE(ink): total energy consumption for SKU k in operation n in location i (KJ)
SE(ik): total energy consumption for SKU k in location i (KJ)
SE(k): total energy consumption for SKU k (KJ)
SCO(ink): total carbon emission for SKU k in operation n in location i (tons)
SCO(nk): total carbon emission for SKU k in operation n (tons)
SCO(ik): total carbon emission for SKU k in location i (tons)
SCO(k)L total carbon emission of SKU k (tons)
USCO(ik): Unit carbon emission of SKU k in location i (grams per unit)

USCO(k)=Unit carbon emission of SKU k (grams per unit)

A first option for the Sustainability Metrics Calculation comprises the following four steps:

### Step 1: Equipment Carbon and Energy Calculation:

EE(ijt)=H(ij)R(ijt)

ECO(ij)=Sum of {EE(ijt)CO(ijt)} for all t

### Step 2 Location Carbon and Energy Calculation:

LE(it)=sum of {EE(ijt)} over all j

LCO(i)=sum of {ECO(ij)} over all j

### Step 3 Operation Carbon and Energy Calculation:

OC(in)=Sum of {EE(ijt)O(ijn)} over all j and all t

OCO(in)=Sum of {ECO(ij)} over all j

### Step 4 SKU Carbon and Energy Calculation:

SE(ink)=Wink OE(in)

SE(ik)=Sum of {SE(ink)} over all n

SE(nk)=Sum of {SE(ink)} over all i

SE(k)=Sum of {SE(ink)} over all n and all i

SCO(ink)=Wink OCO(in)

SCO(ik)=Sum of {SCO(ink)} over all n

SCO(nk)=Sum of {SCO(ink)} over all i

SCO(k)=Sum of {SCO(ink)} over all n and all i

USCO(ik)=1,000,000 SCO(ik)/T(ik)

USCO(k)=Sum of {USCO(ik)} over all i

A second option replaces the energy consumption EE(ijt) with a revised energy consumption REE (ijt) using the following formula, and then follows Steps 1-4 of the above-discussed first option.

Revised Energy Consumption Calculation:

REE(ijt)=(EE(ijt)/LE(it))RLE(it)

If energy consumption EE(ijt) is not reliable or not accurate, option 2 may be recommended to use. In an embodiment, all the sustainability metrics are calculated for a given time period (e.g., day, week, month, quarter, year).

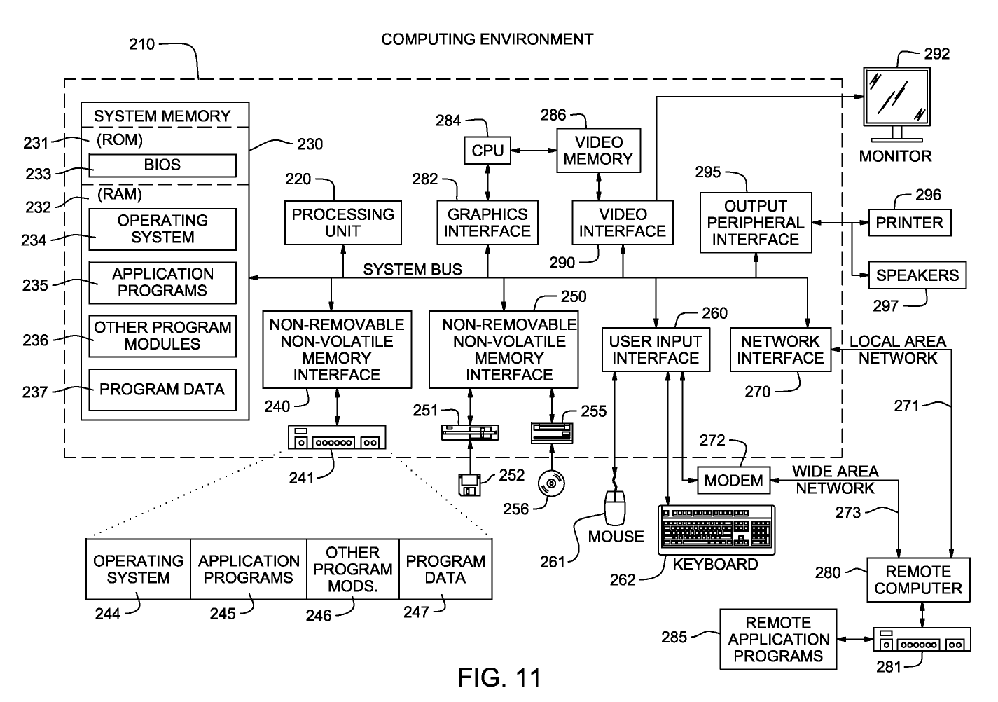

FIG. 11 illustrates an example of a suitable computing system environment 200 in which the invention may be implemented, although as made clear above, the computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 600.

With reference to FIG. 11, an exemplary system for implementing the invention includes a general purpose-computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 11 illustrates operating system 234, application programs 235, other program modules 236, and program data 237.

The computer 210 may also include other removable/non-removable, volatile/nonvolatile computer storage media. By way of example only, FIG. 11 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 11 provide storage of computer readable instructions, data structures, program modules and other data for the computer 210. In FIG. 11, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies.

A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus 221, but may be connected by other interface and bus structures, such as a parallel port, game port or a universal serial bus (USB).

A monitor 291 or other type of display device is also connected to the system bus 221 via an interface, such as a video interface 290. A graphics interface 282, such as Northbridge, may also be connected to the system bus 221. Northbridge is a chipset that communicates with the CPU, or host-processing unit 220, and assumes responsibility for accelerated graphics port (AGP) communications. One or more graphics processing units (GPUs) 284 may communicate with graphics interface 282. In this regard, GPUs 284 generally include on-chip memory storage, such as register storage and GPUs 284 communicate with a video memory 286. GPUs 284, however, are but one example of a coprocessor and thus a variety of co-processing devices may be included in computer 210. A monitor 291 or other type of display device is also connected to the system bus 221 via an interface, such as a video interface 290, which may in turn communicate with video memory 286. In addition to monitor 291, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 11. The logical connections depicted in FIG. 11 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 610 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 11 illustrates remote application programs 285 as residing on memory device 281. It will be appreciated that the network connections shown are exemplary and other means of establishing a communications link between the computers may be used.

One of ordinary skill in the art can appreciate that a computer 610 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

While it is apparent that the invention herein disclosed is well calculated to fulfill the objectives discussed above, it will be appreciated that numerous modifications and embodiments may be devised by those skilled in the art, and it is intended that the appended claims cover all such modifications and embodiments as fall within the true spirit and scope of the present invention.

1. A method of providing an integrated solution to a set of supply chain optimization problems, the method comprising:
defining a distribution network, vehicle routing, inventory positioning, and environmental sustainability for a supply chain;
combining an optimization of the distribution network, the vehicle routing, the inventory positioning, and the environmental sustainability into a single problem;
storing data in a series of tables including a first table including customer information, a second table including vehicle information, a third table including vehicle routing information, a fourth table including supply product information, and a fifth table including supply location information; and
using a series of analytical engines to take data from and to store data in the series of tables, and to process and to use the data from the series of tables to determine a solution for said single problem.

2. The method according to claim 1, wherein:
the defining includes defining strategic and tactical supply chain operations and goals; and
the combining includes providing a decision support system combining said strategic and tactical supply chain operations and goals.

3. The method according to claim 1, wherein the supply chain has a plurality of operational levels, and the method further comprises providing high level views and operational level views of the supply chain, the high level views including a profit and loss view.

4. The method according to claim 1, wherein the using a series of analytical engines includes:
using an inventory positioning engine to identify an inventory policy based on defined factors including inventory costs and customer service targets; and
using a network analysis engine to identify a network structure and a supply flow in the network structure for each of a plurality of product groups.

5. The method according to claim 4, wherein the using a series of analytical engines further includes:
using a vehicle routing and customer clustering engine to identify routes for delivering the products to a multitude of customers; and
using a sustainability engine to quantify an impact of defined actions in the supply chain on energy use and carbon emissions.

6. The method according to claim 5, wherein the vehicle routing and customer clustering engine clusters the multitude of customers into a multitude of customer clusters.

7. The method according to claim 5, wherein the sustainability engine quantifies the impact of specified operational actions in the supply chain on the energy use and carbon emission in warehouse and transportation operations and identifies ways to reduce said energy use and carbon emissions.

8. The method according to claim 5, wherein the using a series of analytical engines further includes using a demand estimation engine to estimate a demand over a specified time period from each of a multitude of customer locations for each of a plurality of items.

9. The method according to claim 5, wherein:
the vehicle routing and customer clustering engine provides input to the network analysis engine and to the sustainability engine;
the network analysis engine provides input to the sustainability engine and to the inventory positioning engine; and
the inventory positioning engine provides input to the sustainability engine.

10. The method according to claim 9, wherein:
the vehicle routing and customer clustering engine assigns customer to routes and assigns routs to cross-docks, and computes demand at the cross-docks;
the network analysis engine assigns cross-docks to local distribution centers and assigns local distribution centers to vendors and to regional distribution centers, and computes demand at the local distribution centers; and
the Inventory Positioning engine determines inventory policy at the regional distribution centers and the local distribution centers, and evaluates alternative supply chains.

11. A system for providing an integrated solution to a set of supply chain optimization problems, the system comprising:
one or more processing units configured for:
defining a distribution network, vehicle routing, inventory positioning, and environmental sustainability for a supply chain;
combining an optimization of the distribution network, the vehicle routing, the inventory positioning, and the environmental sustainability into a single problem;
storing data in a series of tables including a first table including customer information, a second table including vehicle information, a third table including vehicle routing information, a fourth table including supply product information, and a fifth table including supply location information; and
using a series of analytical engines to take data from and to store data in the series of tables, and to process and to use the data from the series of tables to determine a solution for said single problem.

12. The system according to claim 11, wherein the one or more processing units implement:
an inventory positioning engine to identify an inventory policy based on defined factors including inventory costs and customer service targets; and
a network analysis engine to identify a network structure and a supply flow in the network structure for each of a plurality of product groups.

13. The system according to claim 12, wherein the one or more processing units further implement:
a vehicle routing and customer clustering engine to identify routes for delivering the products to a multitude of customers; and
a sustainability engine to quantify an impact of defined actions in the supply chain on energy use and carbon emissions.

14. (canceled)

15. The system according to claim 13, wherein:
the vehicle routing and customer clustering engine provides input to the network analysis engine and to the sustainability engine;
the network analysis engine provides input to the sustainability engine and to the inventory positioning engine; and
the inventory positioning engine provides input to the sustainability engine.

16. An article of manufacture comprising:
at least one tangible computer readable device having computer readable program code logic tangibly embodied therein to provide an integrated solution to a set of supply chain optimization problems, said computer readable program code logic, when executing, performing the following:
identifying a distribution network, vehicle routing, inventory positioning, and environmental sustainability for a supply chain;
combining an optimization of the distribution network, the vehicle routing, the inventory positioning, and the environmental sustainability into a single problem;
storing data in a series of tables including a first table including customer information, a second table including vehicle information, a third table including vehicle routing information, a fourth table including supply product information, and a fifth table including supply location information; and
using a series of analytical engines to take data from and to store data in the series of tables, and to process and to use the data from the series of tables to determine a solution for said single problem.

17. The article of manufacture according to claim 16, wherein said computer readable program code logic, when executing, implements:
an inventory positioning engine to identify an inventory policy based on defined factors including inventory costs and customer service targets; and
a network analysis engine to identify a network structure and a supply flow in the network structure for each of a plurality of product groups.

18. The article of manufacture according to claim 17, wherein said computer readable program code logic, when executing, implements:
a vehicle routing and customer clustering engine to identify routes for delivering the products to a multitude of customers; and
a sustainability engine to quantify an impact of defined actions in the supply chain on energy use and carbon emissions.

19. The article of manufacture according to claim 18, wherein said computer readable program code logic, when executing, implements a demand estimation engine to estimate a demand over a specified time period from each of a multitude of customer locations for each of a plurality of items.

20. The article of manufacture according to claim 18, wherein:
the vehicle routing and customer clustering engine provides input to the network analysis engine and to the sustainability engine;
the network analysis engine provides input to the sustainability engine and to the inventory positioning engine;
the inventory positioning engine provides input to the sustainability engine;
the vehicle routing and customer clustering engine assigns customer to routes and assigns routs to cross-docks, and computes demand at the cross-docks;
the network analysis engine assigns cross-docks to local distribution centers and assigns local distribution centers to vendors and to regional distribution centers, and computes demand at the local distribution centers; and
the inventory positioning engine determines inventory policy at the regional distribution centers and the local distribution centers, and evaluates alternative supply chains.

21. The method according to claim 1, wherein the using a series of analytical engines includes using a computer system, executing a supply chain optimization program, to implement the series of analytical engines to determine a solution for said single problem.
